(19) United States
(12) Patent Application Publication
(10) Pub. No.: US 2026/0228304 A1
(43) Pub. Date: Aug. 6, 2026

(54) DATA PROCESSING SYSTEM

(71) Applicant: NTT DOCOMO, INC., Tokyo (JP)

(72) Inventors: Hiroto AKATSUKA, Tokyo (JP); Masayuki TERADA, Tokyo (JP)

(73) Assignee: NTT DOCOMO, INC., Tokyo (JP)

(21) Appl. No.: 19/152,523

(22) PCT Filed: Dec. 25, 2023
(86) PCT No.: PCT/JP2023/046473

§ 371 Date: Jul. 31, 2025

(30) Foreign Application Priority Data
Mar. 10, 2023 (JP) 2023-037415

(51) Int. Cl. G06F 18/15

(52) U.S. Cl. CPC G06F 18/15

(57) ABSTRACT

A data processing system includes an acquisition unit that acquires a plurality of pieces of time-series data, each associated with a position and having a different attribute, a smoothing unit that performs smoothing on each piece of time-series data acquired by the acquisition unit, and a generation unit that generates new time-series data by non-negativizing negative values included in the time-series data smoothed by the smoothing unit and deducting fluctuations due to the non-negativization from positive values corresponding to the same time in time-series data of another attribute according to the position associated with the time-series data.

### TECHNICAL FIELD

The present invention relates to a data processing system.

### BACKGROUND ART

Conventionally, the use of an exponential smoothing method for quality prediction in product processes has been proposed (see, for example, Patent Literature 1).

### CITATION LIST

### Patent Literature

[Patent Literature 1] Japanese Unexamined Patent Publication No. 2011-85970

### SUMMARY OF INVENTION

### Technical Problem

When utilizing big data, which is large-scale observation data obtained by observing real-world events, a data assimilation process is required to reduce noise included in the observation data and to perform modeling or the like to increase the usefulness of the data. For example, such big data includes time-series population data for each geographical location.

It is conceivable to use, for example, the above-mentioned exponential smoothing method in the process of such time-series data, which is big data. However, when the exponential smoothing method is applied to time-series data whose values are non-negative, such as population data, the time-series data after application may include negative values. It is not appropriate for population data to include negative values. As such, when time-series data has non-negative properties, the time-series data after the application of the exponential smoothing method may violate the non-negative constraint. In this case, if negative values are simply replaced with 0, a positive bias problem occurs, in which the overall values of the time-series data increase. Even when smoothing other than the exponential smoothing method is used, a similar problem may occur depending on the smoothing method.

One embodiment of the present invention has been made in consideration of the above, and an object thereof is to provide a data processing system that can generate appropriately smoothed time-series data.

### Solution to Problem

In order to achieve the above-mentioned object, a data processing system according to one embodiment of the present invention includes an acquisition unit that acquires a plurality of pieces of time-series data, each associated with a position and having a different attribute, a smoothing unit that performs smoothing on each piece of time-series data acquired by the acquisition unit, and a generation unit that generates new time-series data by non-negativizing negative values included in the time-series data smoothed by the smoothing unit and deducting fluctuations due to the non-negativization from positive values corresponding to the same time in time-series data of another attribute according to the position associated with the time-series data.

In the data processing system according to one embodiment of the present invention, new time-series data is generated by non-negativizing negative values included in the smoothed time-series data and deducting the fluctuations due to the non-negativization from positive values corresponding to the same time in time-series data of another attribute according to the position associated with the time-series data. Each of the pieces of generated time-series data does not include negative values, and the negative values are appropriately absorbed into the time-series data of the other attribute. In other words, according to the data processing system according to one embodiment of the present invention, appropriate smoothed time-series data can be obtained.

### Advantageous Effects of Invention

According to one embodiment of the present invention, appropriate smoothed time-series data can be obtained.

### BRIEF DESCRIPTION OF DRAWINGS

FIG. 1 is a diagram illustrating a configuration of a data processing system according to an embodiment of the present invention.

FIG. 2 is a table illustrating an example of population data, which is the time-series data to be processed by the data processing system.

FIG. 3 is a table illustrating an example of population data after smoothing.

FIG. 4 is a table illustrating an example of population data after non-negativization processing, deducting processing, and probabilistic rounding processing.

FIG. 5 is a flowchart illustrating processing executed by the data processing system according to an embodiment of the present invention.

FIG. 6 is a diagram illustrating a hardware configuration of the data processing system according to an embodiment of the present invention.

### DESCRIPTION OF EMBODIMENTS

Hereinafter, a data processing system according to an embodiment of the present invention will be described in detail with reference to the drawings. The same reference signs will be assigned to the same elements in the description of the drawings and duplicate description will be omitted.

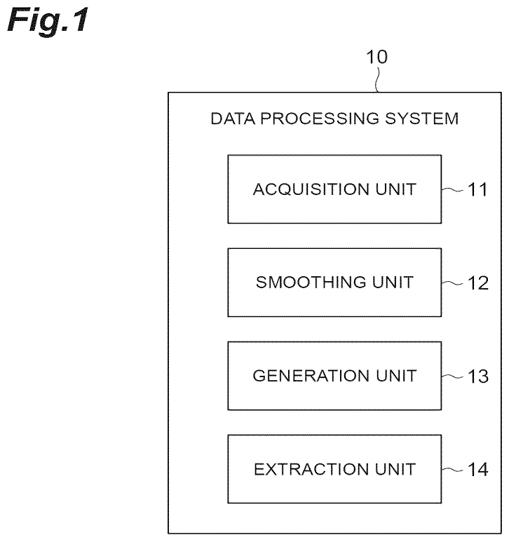

FIG. 1 illustrates a data processing system 10 according to the present embodiment. The data processing system 10 is a system (apparatus) for processing time-series data. The data processing system 10 performs processing, including smoothing, on the time-series data to be processed to generate new time-series data. The time-series data in the present embodiment is a plurality of pieces of time-series data, each associated with a position and having a different attribute.

The time-series data in the present embodiment does not include non-negative values by nature, and is, for example, population data. The smoothing in the present embodiment is performed, for example, for the purpose of reducing noise in the time-series data and analyzing the time-series data. The analysis of the time-series data involves extracting components included in the time-series data. For example, a stationary population and an event population are calculated (separated) from the population indicated by the population data. The stationary population is the population at a stationary time (normal time, usual time), and the event population is the population at a time when an event occurs, which is different from the stationary time. In other words, the data processing system 10 may perform modeling of the time-series data as described above (modeling of population fluctuations in the above-mentioned example).

The time-series data to be processed by the data processing system 10 may be data other than population data, so long as it is a plurality of pieces of time-series data, each associated with a position and having a different attribute. For example, it may be big data, which is large-scale observation data obtained by observing events other than the population in the real world. The processing including smoothing performed by the data processing system 10 may be for purposes other than those mentioned above. In the following, the time-series data will be described as population data.

The data processing system 10 is configured by a computer such as a personal computer (PC) or a server apparatus. The data processing system 10 may be constituted by a plurality of computers. The data processing system 10 may be capable of transmitting and receiving information to and from other apparatuses via a network in order to obtain information necessary for implementing functions.

Next, the functions of the data processing system 10 according to the present embodiment will be described. As illustrated in FIG. 1, the data processing system 10 is configured to include an acquisition unit 11, a smoothing unit 12, a generation unit 13, and an extraction unit 14.

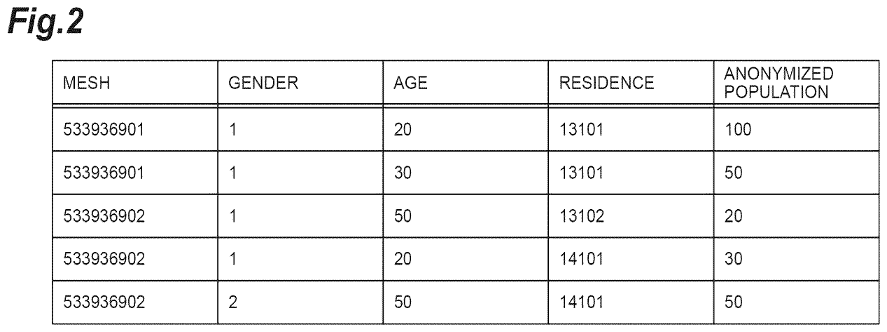

The acquisition unit 11 is a functional unit that acquires a plurality of pieces of time-series data, each associated with a position and having a different attribute. FIG. 2 illustrates an example of population data, which is time-series data in the present embodiment. The population data is data associated with a geographical area (position) and indicates the number of individuals located in that area. The area is, for example, an area obtained by dividing a region. Specifically, the area may be an existing mesh such as a regional mesh. The area may be other than the above, and administrative divisions such as municipalities or prefectures, or preset land use divisions may be used. In the population data illustrated in FIG. 2, the area associated with the population is a mesh.

The population data is time-series data at each time. For example, the population data is data at fixed time intervals (e.g., every 10 minutes). The population data illustrated in FIG. 2 is data at one time among a plurality of times in the time series. The population data is data for each attribute of the people that are the subject of the population. The attributes of people are, for example, gender, age group (e.g., 10-year age groups such as 20s, 30s, and the like), and residence. The attributes may also be ones other than those mentioned above.

The above-mentioned population data is generated by an existing method. For example, the above-mentioned population data is generated as demographic data from the operational data of mobile phone networks, including information indicating the location of mobile phones and registered information on mobile phone subscribers, using existing estimation, anonymization, and analysis functions. The population data may also be generated by any method other than that described above. The population data may be generated in the data processing system 10, or may be generated by a system other than the data processing system 10.

As illustrated in FIG. 2, the population data is data in which meshes, gender, age, residence, and anonymized population are associated. The data illustrated in FIG. 2 is associated with time. In other words, the data illustrated in FIG. 2 is data at each time. The mesh data is an identifier that identifies the mesh related to the population. The mesh identifier is assigned to each mesh in advance.

In the gender data, “1” indicates male and “2” indicates female. The age data is a value that indicates the age group. The residence data is an identifier that identifies the area in which the residence of the person who is the subject of the population is located. The size and division of the area in which the residence is located may be different from the area related to the population (e.g., the mesh described above). For example, the residence identifier is assigned in advance to each area in which the residence is located. The area in which the residence is located is, for example, an administrative division such as a prefecture or a municipality. The residence may also be an area other than that described above.

The anonymized population is the number of individuals (estimated population count) who are present in the corresponding mesh at the corresponding time and who live in the corresponding residence, having the corresponding gender and age. The term “anonymized” indicates that the personal information is concealed when the population data is generated. Records with an anonymized population of 0 may not be included in the population data from the viewpoint of reducing the amount of data.

The data in the first row of the table in FIG. 2 indicates that at the time corresponding to the data, there are 100 people in the mesh indicated by “533936901” who are males, in their 20s, and live in the area of residence indicated by “13101”.

As described above, the population data is time-series data, and includes data as illustrated in FIG. 2 for each of a plurality of times. The population data acquired by the acquisition unit 11 may be in a format other than that described above.

The acquisition unit 11 acquires population data stored in advance in a database of the data processing system 10 or another system. The acquisition unit 11 may acquire population data by any other method. The acquisition unit 11 outputs the acquired population data to the smoothing unit 12.

The smoothing unit 12 is a functional unit that performs smoothing on each piece of time-series data acquired by the acquisition unit 11. The smoothing performed by the smoothing unit 12 may be smoothing based on an exponential smoothing method.

By smoothing the time-series data, for example, it becomes possible to reduce noise in the time-series data and analyze the time-series data. When the smoothing by the smoothing unit 12 is applied to time-series data that does not include non-negative values, the smoothed time-series data may include negative values. For example, the smoothing by the smoothing unit 12 is smoothing based on an exponential smoothing method. It may not be appropriate for the smoothed time-series data to include negative values. For example, it is not appropriate for population data to include negative values.

On the other hand, the performance of the noise reduction and analysis of the time-series data, of the smoothing based on the exponential smoothing method is higher than that of smoothing (e.g., moving average) where negative values cannot be included in the smoothed time-series data. In addition to the exponential smoothing method, there are other high-performance smoothing methods in which negative values can be included in the smoothed time-series data.

In the present embodiment, when the above-mentioned smoothing with high performance is used, negative values included in the smoothed time-series data are eliminated, and appropriate smoothed time-series data is obtained.

The smoothing unit 12 performs smoothing on the time-series data, for example, as follows. The smoothing unit 12 receives population data from the acquisition unit 11. The smoothing unit 12 stores in advance what type of smoothing is to be performed on the population data, and performs smoothing according to the stored information. The smoothing unit 12 performs smoothing on the time-series population data for each combination of the same mesh and the same attribute, that is, for each record illustrated in FIG. 2 in the received population data.

For example, the smoothing unit 12 performs smoothing based on Brown's Linear Exponential Smoothing, which is an exponential smoothing method, according to the following formula to reduce noise. This smoothing is referred to as first smoothing.

$${{S}_{inpu t ( 0 )}^{′}}^{} = {X}_{( 0 )}^{′} \qquad ( 1 )$$

$${{S}_{inpu t ( 0 )}^{″}}^{} = {X}_{( 0 )}^{′} \qquad ( 2 )$$

$${{S}_{inpu t ( t )}^{′}}^{} = {α}_{input} {X}_{( t )}^{′} + ( 1 - {α}_{input} ) {S}_{input ( t - 1 )}^{′} \qquad ( 3 )$$

$${S}_{input ( t )}^{″} = {α}_{input} {S}_{input ( t )}^{′} + ( 1 - {α}_{input} ) {S}_{input ( t - 1 )}^{″} \qquad ( 4 )$$

$${X}_{( t )} = 2 {S}_{{input ( t )}^{-}}^{′} {S}_{i n p u t ( t )}^{″} \qquad ( 5 )$$

In the above-mentioned formula, X′₍ₜ₎ is the population value (anonymized population) at time t in the time-series data to be smoothed. X₍ₜ₎ is the population value at time t in the smoothed time-series data. αᵢₙₚᵤₜ is a decay rate (smoothing coefficient) that is a preset external parameter. αᵢₙₚᵤₜ is a value greater than 0 and less than 1. t=0 is the first time among the times related to the population data to be smoothed. The first smoothing uses values that are continuous (adjacent) in the time direction of the time-series data.

The smoothing unit 12 also performs smoothing based on Brown's Linear Exponential Smoothing, which is an exponential smoothing method, according to the following formula to calculate the stationary population and event population. This smoothing is referred to as the second smoothing. The smoothing unit 12 may perform this smoothing on the population data after the first smoothing. In this way, the smoothing unit 12 may perform a plurality of smoothing operations in sequence on the time-series data. The plurality of smoothing operations may be the same or different from each other.

$${{S}_{stat i c ( 0 )}^{′}}^{} = {X}_{( 0 )} \qquad ( 6 )$$

$${S}_{s t a t i c ( 0 )}^{″} = {X}_{( 0 )} \qquad ( 7 )$$

$${S}_{static ( t )}^{′} = {α}_{s t a t i c X ( t )} + ( 1 - {α}_{s t a t i c} ) {S}_{static ( t - 1008 )}^{′} \qquad ( 8 )$$

$${S}_{static ( t )}^{″} = {α}_{s t a t i c} {S}_{static ( t )}^{′} + ( 1 - {α}_{s t a t i c} ) {S}_{atatic ( t - 1008 )}^{″} \qquad ( 9 )$$

$$static ( t ) = 2 {S}_{stat i c ( t )}^{′} - {S}_{stat i c ( t )}^{″} \qquad ( 10 )$$

In the above-mentioned formula, X₍ₜ₎ is the population value at time t of the time-series data to be smoothed (e.g., the anonymized population after the first smoothing). static₍ₜ₎ is the population value at time t of the smoothed time-series data. t=0 is the first time among the times related to the population data to be smoothed. α_{static} is a decay rate (smoothing coefficient) that is a preset external parameter. α_{static} is a value that is greater than 0 and less than 1.

The calculation of the stationary population and event population is performed based on the assumption that, at stationary times, the population within the same mesh will be the same for the same day of the week and the same time of day of each week. Based on this assumption, the second smoothing uses the values of the time-series data for the same day of the week and the same time of day of each week. If the time interval of the time-series data is 10 minutes, the same day of the week and the same time in the previous week corresponding to time t in the time-series data corresponds to time t-1008. In other words, the time-series data has a periodicity of 1008 intervals in the time direction. The population data after the second smoothing indicates the stationary population.

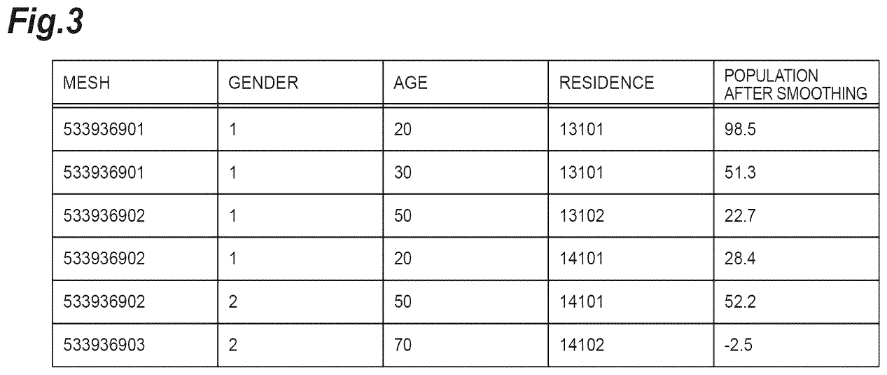

The population data after smoothing is also time-series data at each time, similar to the population data before smoothing. FIG. 3 illustrates an example of time-series data after smoothing by the smoothing unit 12 for the population data illustrated in FIG. 2 (including data at times not illustrated). Similar to the population data illustrated in FIG. 2, the population data illustrated in FIG. 3 is data at one time among a plurality of times in the time series. The data in the smoothed population column in FIG. 3 is the population value calculated by smoothing by the smoothing unit 12.

In the data in the last row of the table in FIG. 3, the smoothed population value is a negative value of −2.5. Note that for the data in the last row of the table in FIG. 3 (data of individuals who are female, in their 70s, living in the residence indicated by “14102”, and who exist in the mesh indicated by “533936903”), the value at the same time before smoothing is 0, and thus, the table in FIG. 2 does not include corresponding data.

Although different from the example in FIG. 3, for example, the time-series data (X′) before smoothing is as illustrated below, and the first smoothing described above is performed with αᵢₙₚᵤₜ=0.5, the time-series data (X) after smoothing is as follows:
X′: 3, 3, 5, 0, 0, 0, 0, 0
X: 3.0, 4.5, 1.25, −0.1875, −0.21875, −0.171875
   In this way, in smoothing based on Brown's Linear Exponential Smoothing, even if the time-series data to be smoothed does not include negative values, the smoothed time-series data may include negative values.

The smoothing unit 12 may perform smoothing other than the exponential smoothing method depending on the purpose of processing the time-series data. The smoothing unit 12 outputs the smoothed population data for each mesh and attribute to the generation unit 13.

The generation unit 13 is a functional unit that generates new time-series data by non-negativizing negative values included in the time-series data smoothed by the smoothing unit 12 and deducting the fluctuations due to the non-negativization from positive values corresponding to the same time in the time-series data of another attribute according to the position associated with the time-series data. The generation unit 13 may determine whether the fluctuations due to the non-negativization of the negative values can be deducted from the time-series data of another attribute associated with the same position as the time-series data including the negative values. If it is determined that the fluctuations due to the non-negativization of the negative values cannot be deducted, the generation unit 13 may generate new time-series data by deducting the fluctuations due to the non-negativization of the negative values from time-series data associated with a different position from the time-series data including the negative values.

The generation unit 13 generates population data, which is new time-series data, for example, as follows. The generation unit 13 non-negativizes negative values included in the population data. For example, the generation unit 13 sets negative values to 0. Furthermore, the generation unit 13 deducts, from the value of another population data at the same time as the time related to the non-negativized value, the amount of fluctuation increased by the non-negativization, for example, in the case where the negative value is replaced with 0, the absolute value of the negative value. Deducting the values according to the non-negativization makes it possible to prevent the occurrence of a positive bias problem in which the overall values of the population data increase. Note that the sum of the population for each location and each attribute may differ before and after non-negativization, but in cases where there are many locations and attributes, such as large-scale population data, this is not a major problem (compared to the population data including negative values and the occurrence of a positive bias problem).

Specifically, the generation unit 13 performs the above-mentioned non-negativization and deducting of values according to the non-negativization as follows. The generation unit 13 receives the smoothed population data from the smoothing unit 12. The generation unit 13 sets to zero, that is, non-negativizes, the population values that are negative across all attributes for each combination of mesh and time associated with the population data. In addition to the non-negativization, the generation unit 13 calculates the sum of the negative values that have been non-negativized for each combination of mesh and time. As described above, when records with a population value of 0 are not to be included in the population data, the generation unit 13 removes records with a negative population value from the population data. In addition, the generation unit 13 calculates the sum of the population values that are positive across all attributes for each combination of mesh and time associated with the population data. The calculated sum of the negative values and the sum of the positive values of the population are values for each combination of mesh and time.

The generation unit 13 compares the absolute value of the calculated sum of the negative population values with the calculated sum of the positive population values for each combination of the same mesh and time. If the absolute value of the sum of the negative population values is equal to or less than the sum of the positive population values, the generation unit 13 determines that the fluctuations due to the non-negativization of the negative population values can be deducted from the time-series data of other attributes for the combination of the same mesh and time. In other words, the generation unit 13 determines that the fluctuations due to the non-negativization of the negative population values can be deducted from the time-series data of other attributes associated with the same position as the time-series data including the negative population values.

In this case, the generation unit 13 deducts (subtracts) values evenly from the population values that are positive for the population data for the combination of the same mesh and time so that the sum of the deducted values is equal to the absolute value of the sum of the negative population values (across different attributes). Note that, depending on the population values that are positive, the subtraction may result in the values becoming negative. However, the subtraction is performed until the values become zero at most but not becoming negative, and any deficits of the subtraction are evenly subtracted from the population data of all other attributes that can be further subtracted.

If the absolute value of the sum of the negative values is greater than the sum of the positive values, the generation unit 13 determines that the fluctuations due to the non-negativization of the negative values cannot be deducted from the time-series data of the other attributes for the combination of the same mesh and time. In other words, the generation unit 13 determines that the fluctuations due to the non-negativization of the negative values cannot be deducted from the time-series data of the other attributes associated with the same position as the time-series data including the negative values.

In this case, the generation unit 13 deducts (subtracts) values evenly from the population values that are positive for the population data for the combination of all meshes (not the same mesh) and the same time so that the sum of the deducted values is equal to the absolute value of the sum of the negative values. Note that, depending on the population values that are positive, the subtraction may result in the values becoming negative. However, the subtraction is performed until the values become zero at most but not becoming negative, and any deficits of the subtraction are evenly subtracted from other population data that can be further subtracted.

In this case, the generation unit 13 may perform subtraction not from the population data of all meshes, but from the population data of meshes having a preset positional relationship with the mesh related to the non-negativized population data. For example, subtraction may be performed from the population data of meshes adjacent to or in the vicinity of the mesh related to the non-negativized population data.

The population data in which the population values of the population data have been non-negativized and deducted by the generation unit 13 is the new population data (new time-series data). In addition, when it is appropriate for the values of the time-series data to be integers, as in the population data of the present embodiment, the generation unit 13 may treat each value of the time-series data, for example, each population value, as an integer. For example, probabilistic rounding may be performed in which the fractional part is treated as a probability to stochastically round the value up or down to the nearest integer.

For example, if the population value after non-negativization and deduction is 50.8, the population value may be rounded to 51 with a probability of 0.8 after the decimal point, and the population value may be rounded to 50 with a probability of the remaining 0.2. The population value may be rounded to an integer by any method other than probabilistic rounding, such as rounding to the nearest integer. When rounding to an integer is performed, the rounded population data is used as new population data (new time-series data). The rounding of the values of the time-series data may be performed according to the time-series data, and may not be performed depending on the time-series data.

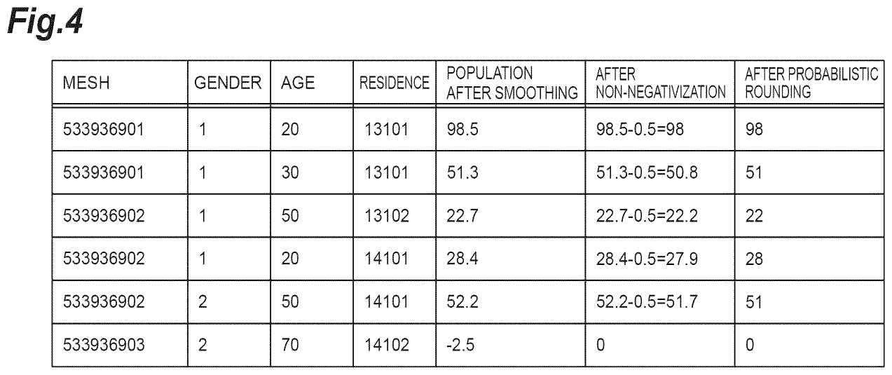

An example of time-series data after non-negativization and deducting processing, and after probabilistic rounding processing by the generation unit 13 for the smoothed time-series data illustrated in FIG. 3 is illustrated in FIG. 4. The data in the column after non-negativization in FIG. 4 is the population value calculated by the non-negativization and deducting processing of the generation unit 13, and the data in the column after probabilistic rounding is the population value calculated by the probabilistic rounding processing of the generation unit 13.

In the example illustrated in FIG. 4, non-negativization is performed on the smoothed negative population value (−2.5) in the last row and the population value after non-negativization becomes 0. In this example, the negative value cannot be absorbed within the same mesh (the mesh indicated by “533936903”). Therefore, the absolute value of the negative value is divided by the number of records in which the population value is positive for all meshes at the same time, and the resulting value (0.5) is subtracted from all positive population values. If negative values can be absorbed within the same mesh (the mesh indicated by “533936903”), the absolute value of the negative values is divided by the number of records in which the population values are positive in the same mesh at the same time, and the resulting value is subtracted from all positive population values in the same mesh.

When the smoothing unit 12 generates a plurality of pieces of smoothed population data different from each other for the population data, the generation unit 13 performs the above-mentioned processing on each smoothed population data to generate new population data for each smoothed population data. For example, when the smoothing unit 12 performs only the first smoothing on the population data and the second smoothing on the population data after the first smoothing to generate two pieces of smoothed population data, the generation unit 13 generates new population data for each of the two pieces of smoothed population data.

Note that the generation of new time-series data by the generation unit 13 does not necessarily have to be performed as described above, and may be performed in any manner, as long as it is performed by non-negativizing negative values included in the smoothed time-series data and deducting the fluctuations due to the non-negativization from the positive values corresponding to the same time of the time-series data of another attribute according to the position associated with the time-series data.

The generation unit 13 may output the generated new time-series data as the result of the analysis (data processing) by the data processing system 10. For example, the generation unit 13 transmits the new time-series data to a system, apparatus, or module other than the data processing system 10. Alternatively, the generation unit 13 may output (e.g., display) the new time-series data in a format that can be recognized by a user by an output apparatus (e.g., a display apparatus) included in the data processing system 10. The generation unit 13 may also output information related to the generated new time-series data by a method other than the above-mentioned method.

When the new time-series data generated by the generation unit 13 is used for extraction by the extraction unit 14, the new time-series data is output to the extraction unit 14. For example, when the event population is extracted by the extraction unit 14, the first new population data generated by the generation unit 13 from the smoothed population data after the first smoothing by the smoothing unit 12, and the second new population data generated by the generation unit 13 from the smoothed population data after the first smoothing and the second smoothing by the smoothing unit 12 are output from the generation unit 13 to the extraction unit 14. The first new population data is the population data (estimated population) after noise reduction as described above. The second new population data is the population data indicating the stationary population as described above.

The extraction unit 14 is a functional unit that extracts components included in the new time-series data generated by the generation unit 13 based on the time-series data. The extraction unit 14 extracts components included in the time-series data, for example, as follows. The component extracted by the extraction unit 14 is the event population.

In this case, the extraction unit 14 receives, from the generation unit 13, the population data after noise reduction, which is the first new population data, and the population data indicating the stationary population, which is the second new population data. The extraction unit 14 subtracts the population value of the population data indicating the stationary population from the population value of the population data after noise reduction for each mesh and attribute to calculate the population data indicating the event population. The calculation of the difference between the population data after noise reduction and the population data indicating the stationary population is performed for each time. The population data indicating the event population is also time-series data for each time, similar to the population data after noise reduction and the population data indicating the stationary population.

The extraction unit 14 outputs the population data indicating the event population calculated (extracted) as the result of the analysis (data processing) by the data processing system 10. For example, the extraction unit 14 transmits the population data indicating the event population to a system, apparatus, or module other than the data processing system 10. Alternatively, the extraction unit 14 may output (e.g., display) the population data indicating the event population in a format that can be recognized by a user by an output apparatus (e.g., a display apparatus) included in the data processing system 10. In addition, the extraction unit 14 may output information related to the extracted component by a method other than the above-mentioned method.

Note that the component extracted by the extraction unit 14 based on the new time-series data does not need to be the event population as described above, and any component may be extracted. In addition, the method of extracting the component may be any method other than that described above, as long as it is based on the new time-series data. The functions of the data processing system 10 according to the present embodiment have been described above.

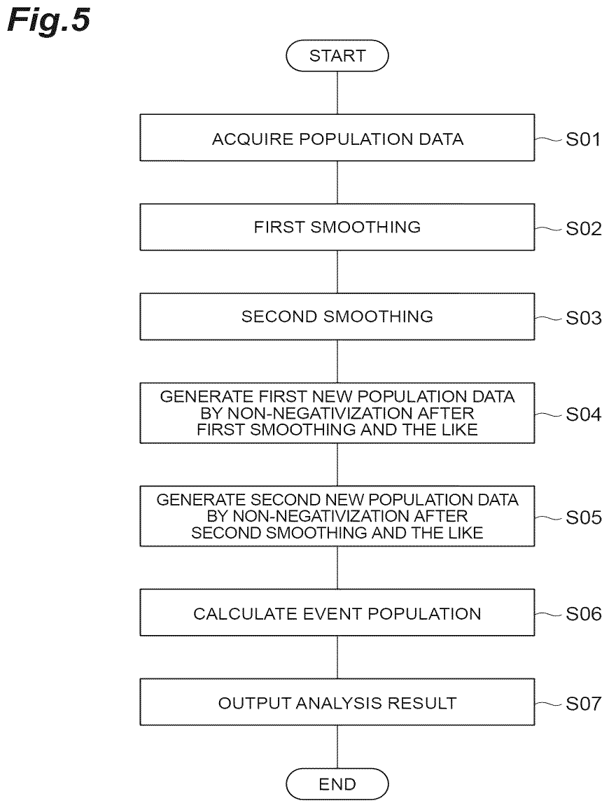

Next, the process executed by the data processing system 10 according to the present embodiment (the operation method performed by the data processing system 10) will be described using the flowchart in FIG. 5. Here, an example will be described in which the stationary population and the event population are calculated from the population data as described above. In this process, first, the acquisition unit 11 acquires population data, which is a plurality of pieces of time-series data, each associated with a position (mesh) and having a different attribute (S01).

Then, the smoothing unit 12 performs the first smoothing on the population data acquired by the acquisition unit 11 (S02). The smoothing unit 12 then performs the second smoothing on the population data after the first smoothing (S03).

Then, the generation unit 13 non-negativizes the negative values included in the population data after the first smoothing. The generation unit 13 also deducts the fluctuations due to the non-negativization from the positive values corresponding to the same time in the population data of another attribute according to the mesh. As a result, the first new population data that has been non-negativized is generated (S04). The first new population data is the population data (estimated population) after noise reduction as described above.

The generation unit 13 also non-negativizes the negative values included in the population data after the second smoothing. The generation unit 13 also deducts the fluctuations due to the non-negativization from the positive values corresponding to the same time in the population data of another attribute according to the mesh. As a result, the second new time-series data that has been non-negativized is generated (S05). The second new population data is the population data indicating the stationary population as described above.

Then, the extraction unit 14 calculates the population data of the event population from the population data after noise reduction (first new population data) and the population data indicating the stationary population (second new population data) (S06). Then, information on the results of the analysis by the data processing system 10 is output (S07). Specifically, the generation unit 13 outputs the population data after noise reduction (first new population data) and the population data indicating the stationary population (second new population data). The extraction unit 14 also outputs the population data of the event population. The process executed by the data processing system 10 according to the present embodiment has been described above.

In the present embodiment, negative values included in the smoothed time-series data are non-negativized, and the fluctuations due to the non-negativization are deducted from the positive values corresponding to the same time in the time-series data of another attribute according to the position associated with the time-series data, whereby new time-series data is generated. In other words, in the present embodiment, non-negativization is performed without bias considering the geographical distribution. Each of the pieces of generated time-series data does not include negative values, and the negative values are appropriately absorbed into the time-series data of the other attribute. In other words, according to the present embodiment, appropriate smoothed time-series data can be obtained. As a result, it is possible to appropriately remove noise from the time-series data and improve the interpretability through modeling of the time-series data.

As in the present embodiment, the generation unit 13 may determine whether the fluctuations due to the non-negativization of the negative values can be deducted from time-series data of another attribute associated with the same position as the time-series data including the negative values, and if it is determined that the fluctuations due to the non-negativization cannot be deducted, the generation unit 13 may generate new time-series data by deducting the fluctuations due to the non-negativization of the negative values from time-series data associated with a different position from the time-series data including the negative values. According to this configuration, it is possible to more reliably obtain appropriate smoothed time-series data. However, the generation of the new time-series data does not necessarily have to be performed as described above.

As in the present embodiment, the data processing system 10 may further include the extraction unit 14 that extracts components included in the new time-series data generated by the generation unit 13 based on the time-series data. According to this configuration, it is possible to appropriately extract components included in the time-series data (e.g., the event population as in the present embodiment) from the appropriate smoothed time-series data. However, the data processing system 10 does not necessarily have to include the extraction unit 14, and may be one in which the generation unit 13 generates new time-series data.

As in the present embodiment, the smoothing may be performed based on an exponential smoothing method. With this configuration, the smoothed time-series data can be obtained appropriately and reliably. However, the smoothing does not have to be based on an exponential smoothing method.

As in the present embodiment, the time-series data may be population data. With this configuration, appropriate smoothed population data can be obtained. However, the time-series data to be processed by the data processing system 10 does not have to be population data, and may be a plurality of pieces of time-series data, each associated with a position and having a different attribute.

In the block diagrams with reference to which the embodiment has been described, blocks of functional units are illustrated. Such functional blocks (component units) are realized by an arbitrary combination of at least one of hardware and software. In addition, a method for realizing each functional block is not particularly limited. In other words, each functional block may be realized by using one apparatus that is combined physically or logically or using a plurality of apparatuses by directly or indirectly (e.g., using a wire or wirelessly) connecting two or more apparatuses separated physically or logically. A functional block may be realized by one apparatus or a plurality of apparatuses described above and software in combination.

The functions include determining, deciding, determination, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (constituent unit) enabling transmission to function is referred to as a transmitting unit or a transmitter. In either case, as described above, realization methods are not particularly limited.

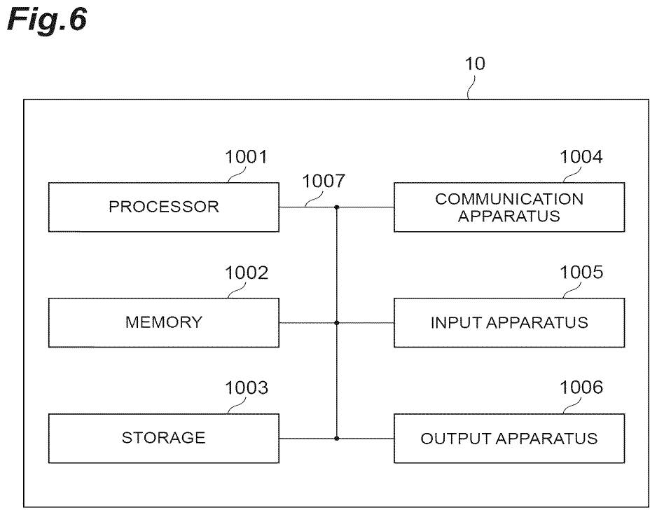

For example, the data processing system 10 according to an embodiment of the present disclosure may function as a computer that performs information processing of the present disclosure. FIG. 6 is a diagram illustrating an example of a hardware configuration of the data processing system 10 according to an embodiment of the present disclosure. The data processing system 10 described above, physically, may be configured as a computer apparatus including a processor 1001, a memory 1002, a storage 1003, a communication apparatus 1004, an input apparatus 1005, an output apparatus 1006, a bus 1007, and the like.

In addition, in the following description, a term “apparatus” may be rephrased as a circuit, a device, a unit, or the like. The hardware configuration of the data processing system 10 may be configured to include one or a plurality of apparatuses illustrated in the drawing and may be configured without including some of these apparatuses.

Each function of the data processing system 10 may be realized when the processor 1001 performs an arithmetic operation by causing predetermined software (a program) to be read onto hardware such as the processor 1001, the memory 1002, and the like, controls communication using the communication apparatus 1004, and controls at least one of data reading and data writing for the memory 1002 and the storage 1003.

The processor 1001, for example, controls the entire computer by operating an operating system. The processor 1001 may be configured as a central processing unit (CPU) including an interface with peripherals, a controller, an arithmetic operation unit, and a register. For example, each function of the data processing system 10 described above may be realized by the processor 1001.

The processor 1001 reads a program (a program code), a software module, data, or the like from the storage 1003 and/or the communication apparatus 1004 to the memory 1002 and performs various processes in accordance therewith. As the program, a program that causes a computer to perform at least some of the operations described above in the embodiment is used. For example, each function of the data processing system 10 may be realized by a control program that is stored in the memory 1002 and operated by the processor 1001. The various processes described above are described as being performed by a single processor 1001, but they may be simultaneously or sequentially performed by two or more processors 1001. The processor 1001 may be mounted as one or more chips. The program may be transmitted from a network via an electrical communication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (main storage apparatus), or the like. The memory 1002 can store an executable program (program code), a software module, or the like that can be executed to perform information processing according to an embodiment of the present disclosure.

The storage 1003 is a computer-readable recording medium and may be constituted by, for example, at least one of an optical disc such as a compact disc ROM (CD-ROM), a hard disk drive, a flexible disk, a magneto-optical disc (e.g., a compact disc, a digital versatile disc, or a Blu-ray (registered trademark) disc), a smart card, a flash memory (e.g., a card, a stick, or a key drive), a floppy (registered trademark) disk, and a magnetic strip. The storage 1003 may be referred to as an auxiliary storage apparatus. The storage medium included in the data processing system 10, for example, may be a database including at least one of the memory 1002 and a storage 1003, a server, or any other appropriate medium.

The communication apparatus 1004 is hardware (a transmitting and receiving device) that performs communication between computers via a wired and/or wireless network and is also referred to as, for example, a network device, a network controller, a network card, or a communication module.

The input apparatus 1005 is an input device (e.g., a keyboard, a mouse, a microphone, a switch, buttons, a sensor, or the like) that accepts an input from the outside. The output apparatus 1006 is an output device (e.g., a display, a speaker, an LED lamp, or the like) that performs output to the outside. In addition, the input apparatus 1005 and the output apparatus 1006 may have an integrated configuration (e.g., a touch panel).

The apparatuses such as the processor 1001 and the memory 1002 are connected to each other via the bus 1007 for transmission of information. The bus 1007 may be configured using a single bus, or may be configured using different buses between apparatuses.

In addition, the data processing system 10 may be configured to include hardware such as a microprocessor, a digital signal processor (DSP), an application specific integrated circuit (ASIC), a programmable logic device (PLD), or a field programmable gate array (FPGA), or some or all of the respective functional blocks may be realized by the hardware. For example, the processor 1001 may be mounted using at least one of these types of hardware.

The order of processes, the sequences, the flowcharts, and the like of the aspects/embodiments described above in the present disclosure may be changed unless conflictions arise. For example, in the methods described in the present disclosure, various steps are described as elements of an exemplary order, but the methods are not limited to the described order.

Information or the like which is input or output may be stored in a specific place (e.g., a memory) or may be managed using a management table. Information or the like which is input or output may be overwritten, updated, or added. The output information and the like may be deleted. The input information and the like may be transmitted to another apparatus.

Determination may be performed using a value (0 or 1) which is expressed by one bit, may be performed using a Boolean value (true or false), or may be performed by comparison of numerical values (e.g., comparison thereof with a predetermined value).

The aspects/embodiments described in this specification may be used alone, may be used in combination, or may be switched during implementation thereof. In addition, a notification of predetermined information (e.g., a notification of being X) is not limited to be performed explicitly and may be performed implicitly (e.g., a notification of the predetermined information is not performed).

As above, while the present disclosure has been described in detail, it is apparent to a person skilled in the art that the present disclosure is not limited to the embodiments described in the present disclosure. The present disclosure may be modified or changed without departing from the concept and the scope of the present disclosure set according to the claims. Thus, the description presented in the present disclosure is for the purpose of exemplary description and does not have any limited meaning for the present disclosure.

It is apparent that software, regardless whether it is called software, firmware, middleware, a microcode, a hardware description language, or any other name, be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, information, and the like may be transmitted and received through a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), at least one of the wired technology and the wireless technology are included in the definition of a transmission medium.

The terms “system” and “network” used in the present disclosure are used interchangeably.

In addition, information, parameters, and the like described in the present disclosure may be expressed using absolute values, may be expressed using values relative to a predetermined value, or may be expressed using other corresponding information.

Terms such as “determining” used in the present disclosure may include various operations of various types. The “determining”, for example, may include a case in which judging, calculating, computing, processing, deriving, investigating, looking up, search, and inquiry (e.g., looking up a table, a database, or any other data structure), or ascertaining is regarded as “determining”. In addition, “determining” may include a case in which receiving (e.g., receiving information), transmitting (e.g., transmitting information), input, output, or accessing (e.g., accessing data in a memory) is regarded as “determining”. Furthermore, “determining” may include a case in which resolving, selecting, choosing, establishing, comparing, or the like is regarded as “determining”. In other words, “determining” includes a case in which a certain operation is regarded as “determining”. In addition, “determining” may be rephrased with “assuming”, “expecting”, “considering”, and the like.

The terms “connected” and “coupled” and every modification thereof refer to direct or indirect connection or coupling between two or more elements and can include that one or more intermediate element is present between two elements “connected” or “coupled” to each other. The coupling or connecting of elements may be physical, may be logical, or may be a combination thereof. For example, “connection” may be read as “access”. When used in the present disclosure, two elements may be considered as being mutually “connected” or “coupled” by using one or more wires and at least one of a cable and a print electric connection and, as several non-limiting and non-comprehensive examples, by using electromagnetic energy having wavelengths in a radio frequency region, a microwave region, and a light (both visible light and non-visible light) region.

The expression “based on” used in the present disclosure does not mean “based on only” unless otherwise described. In other words, description of “on the basis of” means both “only on the basis of” and “at least on the basis of”.

Any referring to elements, for which names of “first”, “second”, and the like are used, used in the present disclosure does not generally limit the amount or the sequence of such elements. The terms can be conveniently used to distinguish two or more elements in the present disclosure. Accordingly, referring to the first and second elements does not mean that only the two elements are employed therein or the first element precedes the second element in a certain form.

When the terms “include” and “including” and modifications thereof are used in the present disclosure, the terms are intended to have a comprehensive meaning similar to the term “comprising”. The term “or” used in the present disclosure is not intended to mean an exclusive logical sum.

In the present disclosure, for example, when an article such as a, an, or the in English is added in translation, the present disclosure may include a case in which a noun subsequent to the article is of a plural type.

In the present disclosure, a term “A and B are different” may mean that “A and B are different from each other”. The expression may mean that “A and B are different from C”. Expressions such as “separated” and “coupled” may be construed in the same way as “different”.

The data processing system of this disclosure has the following configuration.

[1] A data processing system including:
an acquisition unit that acquires a plurality of pieces of time-series data, each associated with a position and having a different attribute;
a smoothing unit that performs smoothing on each piece of time-series data acquired by the acquisition unit; and
a generation unit that generates new time-series data by non-negativizing negative values included in the time-series data smoothed by the smoothing unit and deducting fluctuations due to the non-negativization from positive values corresponding to the same time in time-series data of another attribute according to the position associated with the time-series data.
   [2] The data processing system according to [1], in which the generation unit determines whether the fluctuations due to the non-negativization of the negative values can be deducted from time-series data of the other attribute associated with the same position as the time-series data including the negative values, and if it is determined that the fluctuations due to the non-negativization of the negative values cannot be deducted, generates new time-series data by deducting the fluctuations due to the non-negativization of the negative values from time-series data associated with a different position from the time-series data including the negative values.
   [3] The data processing system according to [1] or [2], further including an extraction unit that extracts components included in the new time-series data generated by the generation unit based on the time-series data.
   [4] The data processing system according to any of [1] to [3], in which the smoothing is performed based on an exponential smoothing method.
   [5] The data processing system according to any of [1] to [4], in which the time-series data is population data.

### REFERENCE SIGNS LIST

10 Data processing system, 11 Acquisition unit, 12 Smoothing unit, 13 Generation unit, 14 Extraction unit, 1001 Processor, 1002 Memory, 1003 Storage, 1004 Communication apparatus, 1005 Input apparatus, 1006 Output apparatus, 1007 Bus

1. A data processing system comprising circuitry configured to:
acquire a plurality of pieces of time-series data, each associated with a position and having a different attribute;
perform smoothing on each piece of time-series data acquired; and
generate new time-series data by non-negativizing negative values included in the time-series data smoothed and deducting fluctuations due to the non-negativization from positive values corresponding to the same time in time-series data of another attribute according to the position associated with the time-series data.

2. The data processing system according to claim 1, wherein the circuitry determines whether the fluctuations due to the non-negativization of the negative values can be deducted from time-series data of the other attribute associated with the same position as the time-series data including the negative values, and if it is determined that the fluctuations due to the non-negativization of the negative values cannot be deducted, generates new time-series data by deducting the fluctuations due to the non-negativization of the negative values from time-series data associated with a different position from the time-series data including the negative values.

3. The data processing system according to claim 1, wherein the circuitry extracts components included in the new time-series data based on the time-series data.

4. The data processing system according to claim 1, wherein the smoothing is performed based on an exponential smoothing method.

5. The data processing system according to claim 1, wherein the time-series data is population data.
